(19) United States
(12) Patent Application Publication
(10) Pub. No.: US 2022/0229966 A1
(43) Pub. Date: Jul. 21, 2022

(54) Method and Apparatus for Locating and Identifying Physical Blocks Within a Grid

(71) Applicant: Kenneth Perlin, New York, NY (US)

(72) Inventor: Kenneth Perlin, New York, NY (US)

(21) Appl. No.: 17/569,479

(22) Filed: Jan. 5, 2022

Related U.S. Application Data
(60) Provisional application No. 63/140,207, filed on Jan. 21, 2021.

(51) Int. Cl. G06F 30/392; G06F 30/398; G06F 30/3953

(52) U.S. Cl. CPC G06F 30/392; H05K 13/083; G06F 30/3953; G06F 30/398

(57) ABSTRACT

An apparatus for showing an arrangement having a plurality of physical blocks which includes a first block having a vertical axis and a second block having a vertical axis. The apparatus includes a grid upon which the plurality of blocks is placed to form an arrangement of blocks with respect to the grid. The apparatus includes a computer in communication with the grid. The computer receiving signals from the grid which reveal a location and an identity of the first block about its vertical axis and the second block about its vertical axis. The signals used by the computer to drive an interactive computer graphic visualization of the arrangement of physical blocks with respect to the grid. The present invention pertains to a method for showing an arrangement.

### CROSS-REFERENCE TO RELATED APPLICATIONS

This is a nonprovisional of U.S. provisional application Ser. No. 63/140,207 filed Jan. 21, 2021, incorporated by reference herein.

### FIELD OF THE INVENTION

The present invention is related to showing an arrangement of physical blocks on a computer graphic visualization. (As used herein, references to the “present invention” or “invention” relate to exemplary embodiments and not necessarily to every embodiment encompassed by the appended claims.) More specifically, the present invention is related to showing an arrangement of physical blocks on an interactive computer graphic visualization utilizing a grid.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When configuring a physical location, it is desirable and helpful to view the possible different configurations of the physical location considered before actually creating them. This not only saves the cost of the actual configuration and the exertion of building and moving the objects, such as furniture or wall placement, but also provides more flexibility and options to consider for the ultimately chosen configuration. Furthermore, it would be even better for considering possible different configurations if the configurations could be viewed from different locations in the configuration itself without having to actually create the configuration.

### BRIEF SUMMARY OF THE INVENTION

The present invention pertains to an apparatus for showing an arrangement. The apparatus comprises a plurality of physical blocks which includes a first block having a vertical axis and a second block having a vertical axis, the second block different from the first block. The apparatus comprises a grid upon which the plurality of blocks is placed to form an arrangement of blocks with respect to the grid. The apparatus comprises a computer in communication with the grid. The computer receiving signals from the grid which reveal a location and an identity of the first block about its vertical axis and the second block about its vertical axis. The signals used by the computer to drive an interactive computer graphic visualization of the arrangement of physical blocks with respect to the grid.

The present invention pertains to a method for showing an arrangement. The method comprises the steps of placing a first block having a vertical axis upon a grid. There is the step of placing a second block having a vertical axis upon the grid. The second block different from the first block. The first block and the second block placed on the grid form an arrangement of blocks with respect to the grid. There is the step of a computer receiving signals from the grid which reveal a location and an identity of the first block about its vertical axis and the second block about its vertical axis. The computer in communication with the grid. There is the step of the computer using the signals to drive an interactive computer graphic visualization of the arrangement of physical blocks with respect to the grid.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows each block contains on its bottom face one of 120 unique 3×3 identifying patterns.

FIGS. 2A, 2B and 2C show three layers of traces used to determine the presence, location, identity and orientation of any block. FIG. 2A shows the first printed layer, comprised of electrically conductive ink. FIG. 2B shows the second printed layer, comprised of an insulating dielectric ink. FIG. 2C shows the third printed layer, comprised of an electrically conductive ink.

FIG. 3A shows a first printed layer.

FIG. 3B shows a first printed layer with a second printed layer on top of it.

FIG. 3C shows a first printed layer with a second printed layer on top of it and a third printed layer on top of the second printed layer.

FIG. 4 shows the conducting regions on the bottom face of the base of each block.

FIG. 5 shows on the upper face of the base of each block, a diode on some of these 9 pairs of electrical connectors which connects the inner region with the outer region.

FIG. 6 shows a set of raised ridges imposed on the sensing surface.

FIG. 7A shows a top-down view of blocks upon a sensing surface.

FIG. 7B shows a perspective view of blocks upon a sensing surface.

FIG. 7C shows a corresponding data structure associated with FIGS. 7A and 7B.

FIG. 8 shows a block which initially has the identifier code as shown on the left.

FIG. 9A shows a cross-section of a push-button block in its up (non-pressed) state.

FIG. 9B shows a cross-section of a push-button block in its down (pressed) state.

FIG. 10A shows the bottom of the block of FIGS. 9A and 9B, which contains nine pairs of connectors.

FIG. 10B shows the bottom of the block of FIGS. 9A and 9B showing the two regions of the block where the positive and negative ends of the diode, respectively, make contact with the positive and negative regions, respectively, of the central pair of connectors when the block is in its down (pressed) state.

FIG. 11 is a representation of the apparatus of the invention.

### DETAILED DESCRIPTION OF THE INVENTION

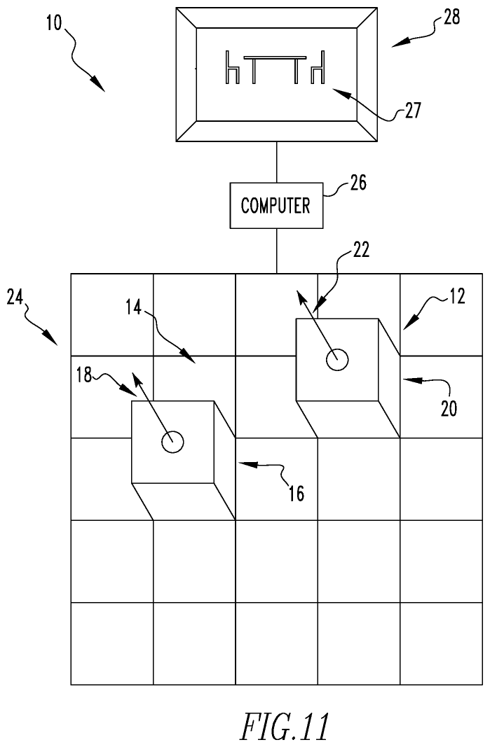

Referring now to the drawings wherein like reference numerals refer to similar or identical parts throughout the several views, and more specifically to FIG. 11 thereof, there is shown an apparatus 10 for showing an arrangement 12. The apparatus 10 comprises a plurality of physical blocks 14 which includes a first block 16 having a vertical axis 18 and a second block 20 having a vertical axis 22, the second block 20 different from the first block 16. The apparatus 10 comprises a grid 24 upon which the plurality of blocks 14 is placed to form an arrangement 12 of blocks 14 with respect to the grid 24. The apparatus 10 comprises a computer 26 in communication with the grid 24. The computer 26 receiving signals from the grid 24 which reveal a location and an identity of the first block 16 about its vertical axis 18 and the second block 20 about its vertical axis 22. The signals used by the computer 26 to drive an interactive computer graphic visualization 27 of the arrangement 12 of physical blocks 14 with respect to the grid 24.

Each block 14 of the plurality of blocks 14 can be oriented in any one of four principal compass directions upon the grid 24. The signals from the grid 24 reveal the location, the identity and the orientation of the first block 16 about its vertical axis 18 and the second block 20 about its vertical axis 22. The apparatus 10 may include a virtual reality display 28 upon which the interactive computer graphic visualization 27 of the arrangement 12 of physical blocks 14 with respect to the grid 24 is displayed.

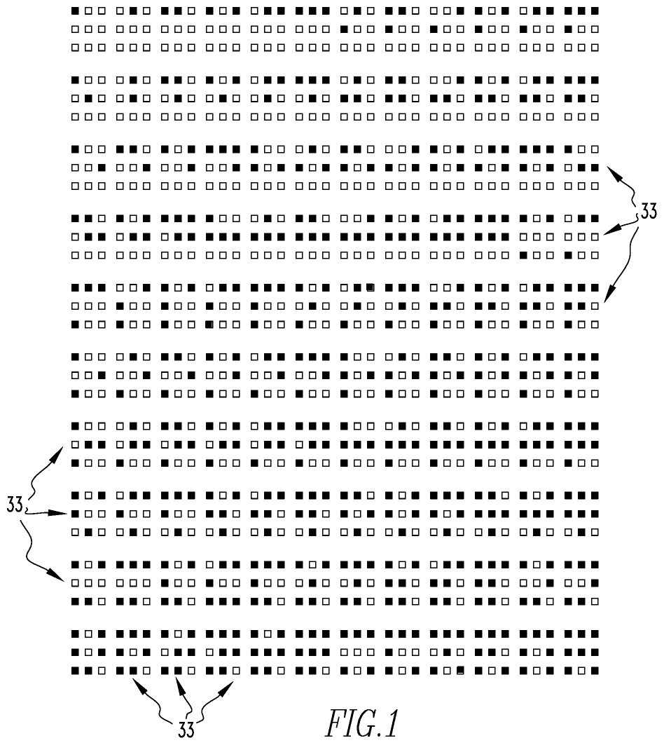

Each block 14 may have a bottom face 30 with a unique identifying pattern 33 from every other block, as shown in FIG. 1. The unique identifying pattern 33 may be one of 120 unique 3×3 identifying patterns 33, and for each of these 120 kinds of identifying patterns 33 on the blocks 14, each block's rotation about its vertical axis 18 in one of four principal orientations 0, 90, 180 and 270 degrees, respectively, can be detected.

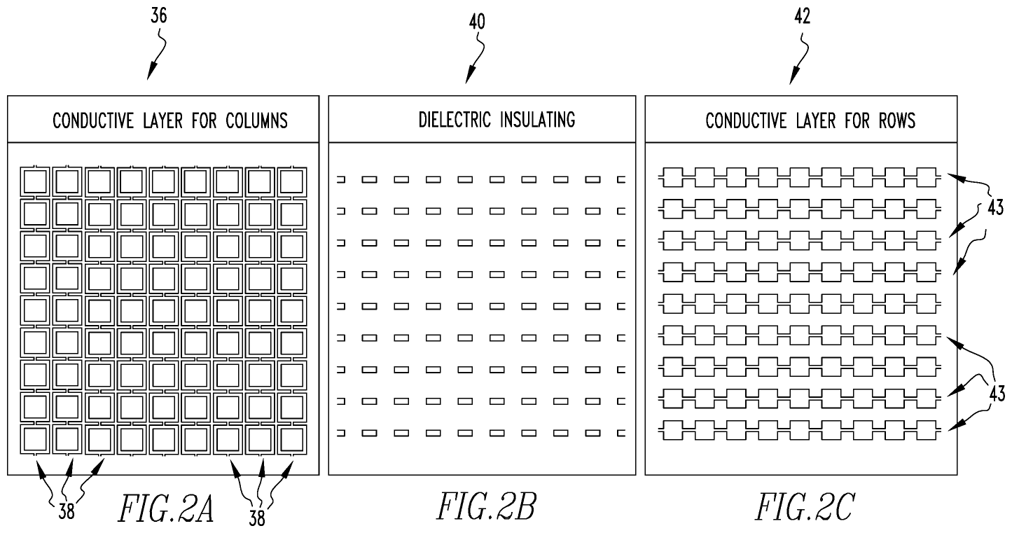

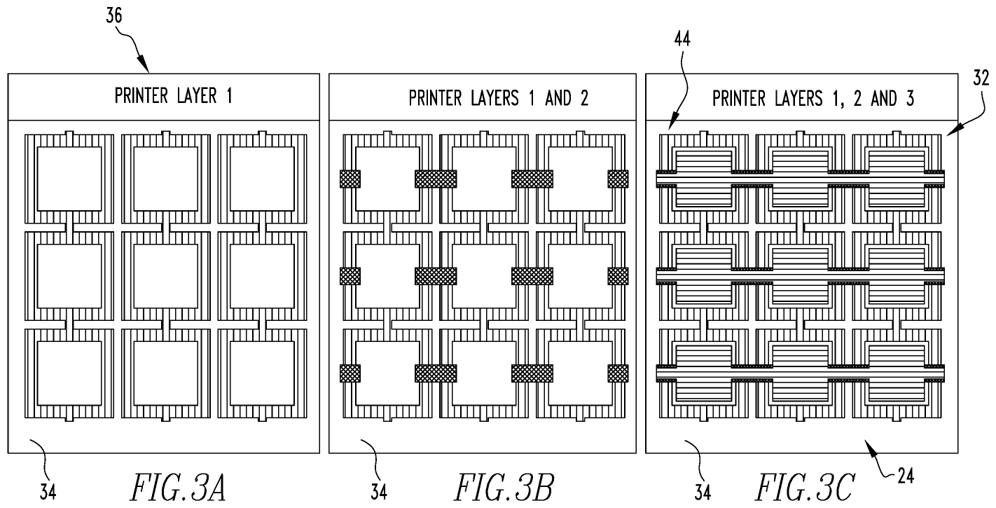

Referring to FIGS. 2A, 2B, 2C, 3A, 3B and 3C, the apparatus 10 may include a scanning sheet 32 having a substrate 34; a first printed layer 36 comprised of electrically conductive ink which provides electrical connectivity for individual columns 38 disposed directly on the substrate 34; a second printed layer 40 comprised of an insulating dielectric ink which is disposed directly on the first printed layer 36; and a third printed layer 42 comprised of an electrically conductive ink which provides electrical conductivity for individual rows disposed on the second printed layer 40. The second printed layer 40 provides electrical insulation between the first and third layers where the electrically conductive regions of the first printed layer 36 and the second printed layer 40 cross. The first, second and third printed layers 36, 40, 42 form a printed circuit pattern 44 used to determine presence, location, identity and orientation of any block 14 on the printed circuit pattern 44.

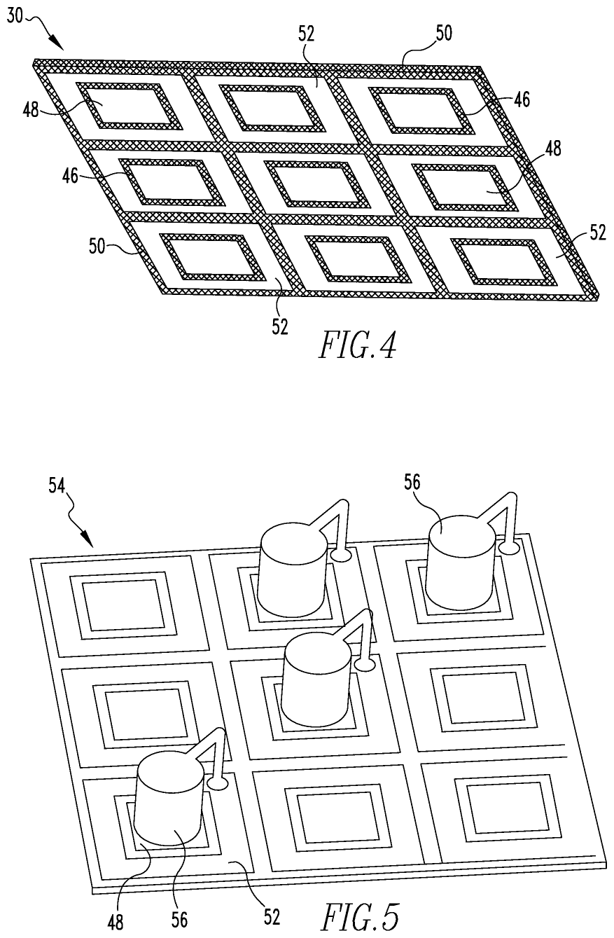

Each block 14 may be disposed atop three successive rows and three successive columns 38 of the printed circuit pattern 44. Electricity flows through the first printed layer 36 in a north/south direction, and electricity flows through the third layer in the east/west direction. A bottom face 30 of a base of each block 14 is a 3×3 arrangement of pairs of electrical connectors, as shown in FIG. 4. A first connector 46 of each pair of electrical connectors may be disposed in an inner region 48 of the bottom face 30 and a second connector 50 of each pair may be disposed in an outer region 52 of the bottom face 30 which surrounds the inner region 48. On an upper face 54 of the base of each block, at least one of the pairs of electrical connectors has a diode 56 that connects the inner region 48 with the outer region 52, as shown in FIG. 5.

The present invention pertains to a method for showing an arrangement 12. The method comprises the steps of placing a first block 16 having a vertical axis 18 upon a grid 24. There is the step of placing a second block 20 having a vertical axis 22 upon the grid 24. The second block 20 different from the first block 16. The first block 16 and the second block 20 placed on the grid 24 form an arrangement 12 of blocks 14 with respect to the grid 24. There is the step of a computer 26 receiving signals from the grid 24 which reveal a location and an identity of the first block 16 about its vertical axis 18 and the second block 20 about its vertical axis 22. The computer 26 in communication with the grid 24. There is the step of the computer 26 using the signals to drive an interactive computer graphic visualization 27 of the arrangement 12 of physical blocks 14 with respect to the grid 24.

There may be the step of displaying the interactive computer graphic visualization 27 of the arrangement 12 of physical blocks 14 with respect to the grid 24 in a virtual reality display 28. Each block 14 of the plurality of blocks 14 can be oriented in any one of four principal compass directions on the grid 24. The signals from the grid 24 may reveal the location, the identity and the orientation of the first block 16 about its vertical axis 18 and the second block 20 about its vertical axis 22.

A method and apparatus 10 are described that allows its users to place physical blocks 14 of different kinds into a rectangular grid 24, such that each block 14 can be oriented in one of the four principal compass directions, and such that a computer 26 can detect the location, identity and orientation about its vertical axis 18 of each block. This information can be used to drive an interactive computer graphic visualization 27 of the arrangement 12 of physical blocks 14, which can also be displayed in virtual reality.

One application of this invention is in helping its user to design the interior of a house. For this application, the individual blocks 14 can be in the shape of chairs, tables, walls, doorways, lamps and other items that can represent furniture or structural elements. As the user places each block 14 which is in the shape of the item it represents, a computer 26 registers the identity, position within the grid 24, and north/south/east/west orientation of that block. This information can then be used by computer software, which would be easy to implement by one practiced in the art, to visualize the room either on a computer screen or in a virtual reality world which the user could walk around within.

List of Parts:

1. Grid 24 with patterned conductive ink

2. Computer 26

3. Microprocessor to control scanning

4. One or more physical blocks 14

User Experience:

The user places physical blocks 14 within a grid 24 of squares on a surface. The blocks 14 can be of many different shapes, but each block 14 has a square base that fits well into one of the squares of the surface. When the user inserts any block 14 into a square slot of the surface, the user can also see a digital representation of that particular block, with its correct orientation, on a computer screen or in a virtual reality representation.

Technical Enablement:

In one embodiment, tracking and identification of the blocks 14 is done by having each block 14 contain on its bottom face 30 one of 120 unique 3×3 identifying patterns, as shown in FIG. 1.

Using this approach, up to 120 distinct kinds of blocks 14 can be uniquely identified. For each of these 120 kinds of block, a block's rotation about its vertical axis 18 can also be detected in one of the four principal orientations 0, 90, 180 and 270 degrees, respectively.

In order to determine the presence, location, identity and orientation of any block, in one embodiment a scanning method is implemented via an electrically connected scanning sheet 32 as follows. Three layers of traces are successively printed onto a substrate 34 which can be comprised of flexible plastic. The first printed layer 36, comprised of electrically conductive ink, provides electrical connectivity for individual columns 38. The second printed layer 40, comprised of an insulating dielectric ink, provides electrical insulation between the first and third layers where their electrically conductive regions cross. The third printed layer 42, comprised of an electrically conductive ink, provides electrical conductivity for individual rows (FIGS. 2A, 2B and 2C).

Each block 14 will sit atop three successive rows and three successive columns 38 of the printed circuit pattern 44, shown in FIGS. 3A, 3B and 3C. When the first (conductive) layer is printed, electricity is able to flow in the north/south direction. When the second (insulating) layer is printed, the first layer is insulated from the (still to be deposited) third layer. When the third layer is printed, electricity is able to flow in the east/west direction.

On the bottom face 30 of the base of each block 14 is a 3×3 arrangement of pairs of electrical connectors. One of these connectors is an inner region 48 and the other is an outer region 52 which surrounds the inner region 48. In FIG. 4, the conducting regions are the non-crosshatched areas.

On the upper face 54 of the base of each block, some of these 9 pairs of electrical connectors contain a diode 56 that connects the inner region 48 with the outer region 52, as shown in FIG. 5. The presence of a diode 56 corresponds to the black regions in each of the patterns from FIG. 1. In particular, the pattern shown in FIG. 5 corresponds to the 55th pattern from FIG. 1.

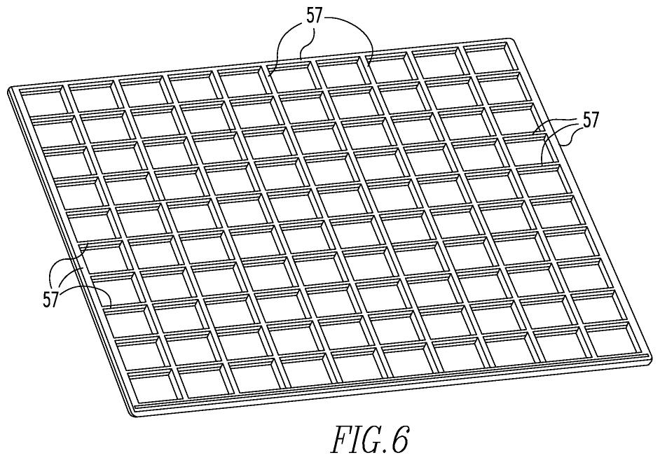

To keep the blocks 14 physically aligned with the grid 24, in one embodiment a set of raised ridges 57 is imposed on the sensing surface, as shown in FIG. 6.

Scanning of the rows 43 and columns 38 of the sensing surface is performed, as is taught in U.S. patent, US20120086659A1, incorporated by reference herein, the method of which can be adapted by one skilled in the art. In that regard, a microprocessor controls the sequencing, row 43 by row 43, of the grid 24, retrieving a value for every column 38 as each row 43 is activated in succession. The computer 26 then receives from the microprocessor an array of (nRows*nColumns) digital values, representing the presence or absence of an electrical connection at each row/column intersection. The microprocessor is electronically connected to the grid 24. It may or may not be physically attached to the grid 24. It could just be a separate component attached by wire to the grid 24.

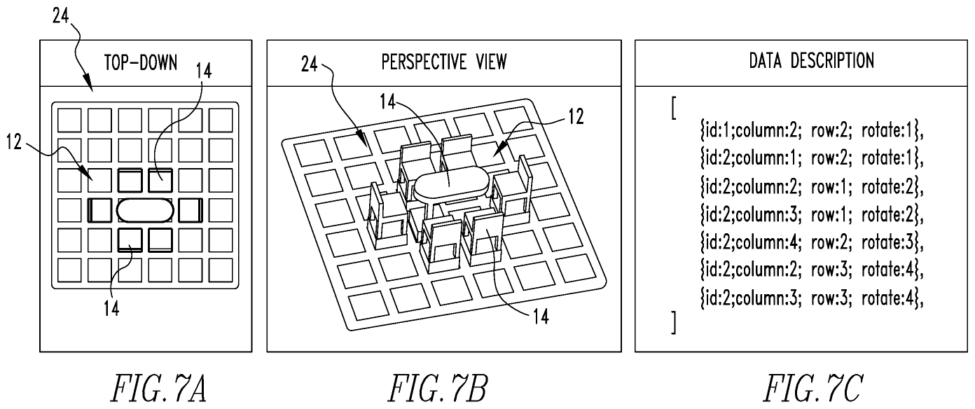

By this technique, for any physical arrangement 12 of blocks 14 upon the sensing surface, a corresponding software data structure can be constructed, where each record identifies the following: (a) a block 14 identifier, which can be an integer from 1 through 120, (b) a row number, (c) a column number, and (d) a block 14 orientation about its vertical axis 18, which can be an integer from 1 through 4. FIGS. 7A, 7B and 7C show seven blocks 14 used to represent an arrangement 12 of six chairs around a table, together with the resulting data representation of those blocks 14.

In one embodiment, the electrical current from the surface can be used to activate lights, motors, audio transducers and/or other electrical devices within any physical block. These components can draw power from the grid 24 below. If the electrical load for any device is so large that it might cause errors in the identification and location of the blocks 14, then power from the grid 24 should not be used to power the additional components of the block. In such an instance, the block 14 can have an alternative source of power, such as a small battery contained within the block 14 that is used to activate components within the block.

In addition, push buttons or other kinds of physical switches can be added to a block. When the user presses down on a push button or otherwise toggles a switch, the movement causes the internal diode 56 of one of the connectors to become connected to its corresponding connector pair at the base of the block. This changes the identifier number of the block. The computer software detects that a block 14 has changed its identifier number, and can use that information to flag the button press.

For example, consider a block 14 which initially has the identifier pattern 33 as shown on the left in FIG. 8. The push button 65 on the top of this block 14 mechanically connects, via a solid vertically movable shaft 69, to a diode 56 which is positioned just above the bottom center of the block. This diode 56 is normally in a raised position, and is therefore not electrically connected to the connectors at the base of the block. When the user presses down upon the push button 65 on the top of the block, the movable shaft 69 moves downward, thereby closing an electrical connection between this diode 56 and the connector below it. As a result, while the push button 65 is pressed, the identifier pattern 33 on the block 14 changes to the pattern 33 shown on the right in FIG. 8. The described technique does not require the use of any additional power source or other electronic components.

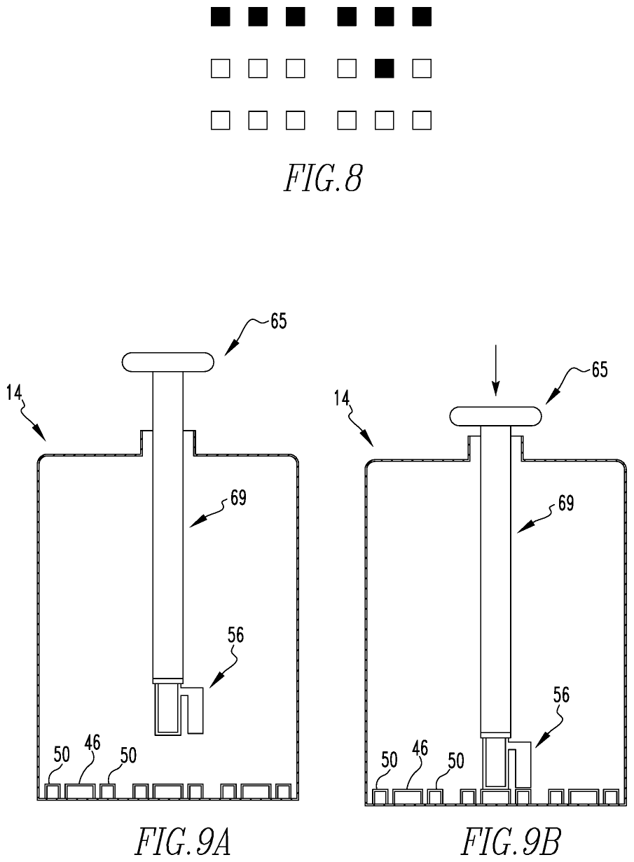

FIGS. 9A and 9B show a cross-section of a push-button 65 block 14 in two states. In FIG. 9A, the block 14 is shown in its up (non-pressed) state, and in FIG. 9B, the block 14 is shown in its down (pressed) state. Note that the positive and negative ends of the diode 56 make contact with the pair of positive and negative electrical connectors positioned beneath the diode 56 only when the block 14 is in its down (pressed) state.

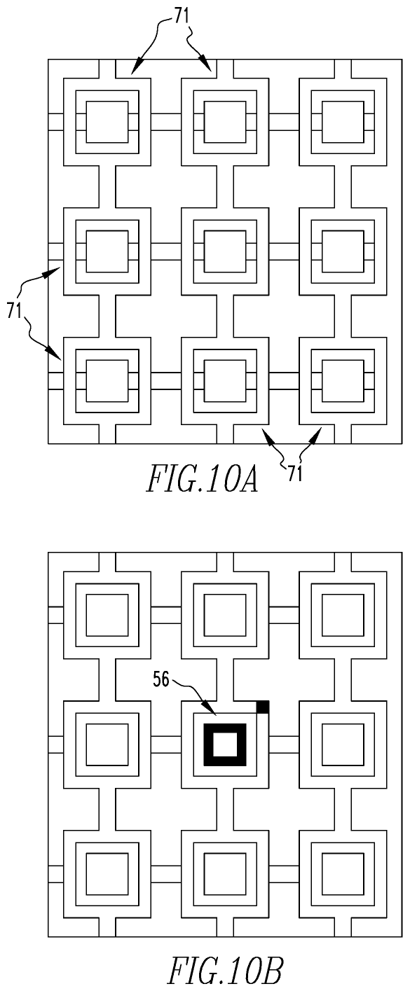

FIGS. 10A and 10B show the bottom of this same block, which contains nine pairs 71 of connectors. In FIG. 10A is depicted the nine pairs 71 of connectors. In FIG. 10B is depicted the two regions of the block 14 where the positive and negative ends of the diode 56, respectively, make contact with the positive and negative regions, respectively, of the central pair 71 of connectors when the block 14 is in its down (pressed) state.

This push-button interaction could be used in the architectural interior design example described earlier. For example, the block 14 could represent a generic chair. Each time the user presses on the 65, the computer software iterates to show another chair from a set of chair visualizations. In this way, the same block 14 can be used as a stand-in for many types of chairs that will be displayed in the accompanying computer visualization 27.

In another example, the block 14 can represent a floor lamp. When the user presses the button 65 on this block, the light in the accompanying computer visualization 27 is toggled. In this way, the user can look at the computer screen or walk around within the accompanying virtual reality simulation to see what is the effect upon room lighting when a lamp in that position within the room is turned on or off.

When the configuration is in virtual reality (VR), the viewer within the virtual reality simulation will be able to move around the visualization 27 using techniques of moving their head or using gesture or VR controllers for navigation that are standard in the art for VR, which are very familiar to one practiced in the art in VR. Because each visualized block 14 in the computer graphic representation of the configuration of blocks 14 is in a well-defined location and orientation in the simulation, changes in the user's virtual position within the simulated world will cause corresponding changes in the user's view of the configuration, as is standard in the art for VR. The visualized blocks 14 in the simulation can be at any scale. In one embodiment, the width of each physical block 14 is one linear inch, the scale difference between the physical blocks 14 and their virtual representation in the VR world is 1:12, and width of the visual representation of each block 14 in VR is, consequently, one linear foot.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An apparatus for showing an arrangement comprising:
a plurality of physical blocks which includes a first block having a vertical axis and a second block having a vertical axis, the second block different from the first block;
a grid upon which the plurality of blocks is placed to form an arrangement of blocks with respect to the grid; and
a computer in communication with the grid, the computer receiving signals from the grid which reveal a location and an identity of the first block about its vertical axis and the second block about its vertical axis, the signals used by the computer to drive an interactive computer graphic visualization of the arrangement of physical blocks with respect to the grid.

2. The apparatus of claim 1 wherein each block of the plurality of blocks can be oriented in any one of four principal compass directions upon the grid.

3. The apparatus of claim 2 wherein the signals from the grid reveal the location, the identity and the orientation of the first block about its vertical axis and the second block about its vertical axis.

4. The apparatus of claim 3 including a virtual reality display upon which the interactive computer graphic visualization of the arrangement of physical blocks with respect to the grid is displayed.

5. The apparatus of claim 4 wherein each block has a bottom face with a unique identifying pattern from every other block.

6. The apparatus of claim 5 where the unique identifying pattern is one of 120 unique 3×3 identifying patterns, and for each of these 120 kinds of identifying patterns on the blocks, each block's rotation about its vertical axis in one of four principal orientations 0, 90, 180 and 270 degrees, respectively, can be detected.

7. The apparatus of claim 6 including a scanning sheet having a substrate, a first printed layer comprised of electrically conductive ink which provides electrical connectivity for individual columns disposed directly on the substrate, a second printed layer comprised of an insulating dielectric ink which is disposed directly on the first printed layer, and a third printed layer comprised of an electrically conductive ink which provides electrical conductivity for individual rows disposed on the second printed layer, the second printed layer provides electrical insulation between the first and third layers where the electrically conductive regions of the first printed layer and the second printed layer cross, the first, second and third printed layers form a printed circuit pattern used to determine presence, location, identity and orientation of any block on the printed circuit pattern.

8. The apparatus of claim 7 wherein each block is disposed atop three successive rows and three successive columns of the printed circuit pattern, electricity flows through the first printed layer in the north/south direction, and electricity flows through the third printed layer in the east/west direction.

9. The apparatus of claim 8 wherein the bottom face of each block has a 3×3 arrangement of pairs of electrical connectors, a first connector of each pair of electrical connectors is disposed in an inner region of the bottom face and a second connector of each pair is disposed in an outer region of the bottom face which surrounds the inner region.

10. The apparatus of claim 9 wherein on an upper face of the base of each block, at least one of the pairs of electrical connectors has a diode that connects the inner region with the outer region.

11. A method for showing an arrangement comprising the steps of:
placing a first block having a vertical axis upon a grid;
placing a second block having a vertical axis upon the grid, the second block different from the first block, the first block in the second block placed on the grid form an arrangement of blocks with respect to the grid;
a computer receiving signals from the grid which reveal a location and an identity of the first block about its vertical axis and the second block about its vertical axis, the computer in communication with the grid; and
the computer using the signals to drive an interactive computer graphic visualization of the arrangement of physical blocks with respect to the grid.

12. The method of claim 11 including the step of displaying the interactive computer graphic visualization of the arrangement of physical blocks with respect to the grid in a virtual reality display.

13. The method of claim 12 wherein each block of the plurality of blocks can be oriented in any one of four principal compass directions on the grid.

14. The method of claim 13 wherein the signals from the grid reveal the location, the identity and the orientation of the first block about its vertical axis and the second block about its vertical axis.
